(19) United States
(12) Patent Application Publication
(10) Pub. No.: US 2011/0017640 A1
(43) Pub. Date: Jan. 27, 2011

(54) RARE EARTH CARBONATE COMPOSITIONS FOR METALS TOLERANCE IN CRACKING CATALYSTS

(76) Inventors: Philip S. Deitz, Windsor Mill, MD (US); Wilson Suarez, Sykesville, MD (US); Richard Wormsbecher, Dayton, MD (US); Ranjit Kumar, Clarksville, MD (US)

Correspondence Address: W.R. GRACE & CO.-CONN., 7500 GRACE DRIVE, COLUMBIA, MD, 21044, US

(21) Appl. No.: 12/936,009

(22) PCT Filed: Jan. 8, 2009
(86) PCT No.: PCT/US09/00094

§ 371 Date: Oct. 1, 2010

Related U.S. Application Data
(60) Provisional application No. 61/010,738, filed on Jan. 11, 2008.
(60) Provisional application No. 61/125,487, filed on Apr. 25, 2008.

(51) Int. Cl. C10G 11/05; B01J 27/232; B01J 29/04

(52) U.S. Cl. 208/118; 502/174; 502/73

(57) ABSTRACT

This is invention is a composition comprising discrete particles that comprise rare earth carbonate, preferably lanthanum carbonate, dispersed in a matrix. The composition may be combined with zeolite-containing cracking catalysts to enhance catalytic activity and/or selectivity in the presence of metals (Ni and V).

### BACKGROUND OF THE INVENTION

The present invention relates to zeolite-containing catalytic cracking catalysts, and more particularly, to cracking catalyst compositions which are capable of converting metals-containing hydrocarbon feedstocks into valuable products such as gasoline and diesel fuel.

When zeolite-containing cracking catalysts are used to process feedstocks which contain metals such as vanadium (V) and nickel (Ni), the metals are deposited on the catalyst in amounts that eventually cause loss of activity and the increased production of undesirable products such as hydrogen and coke.

There are various methods for improving the catalytic cracking activity and selectivity of catalytic cracking catalysts in the presence of V when a rare-earth component is added to the catalyst.

U.S. Pat. No. 3,930,987 describes zeolite-containing cracking catalysts which are impregnated with a solution of rare-earth salts. The soluble rare-earth salts which may be used to prepare the catalysts include rare earth chlorides, bromides, iodides, carbonates, bicarbonates, sulfates, sulfides, thiocyanates, peroxysulfates, acetates, benzoates, citrates, fluorides, nitrates, formates, propionates, butyrates, valerates, lactates, malanates, oxalates, palmitates, hydroxides, tartrates, and the like.

U.S. Pat. No. 4,515,683 discloses a method for passivating vanadium on catalytic cracking catalysts wherein lanthanum is nonionically precipitated on the catalyst prior to ordinary use. In a preferred embodiment lanthanum is precipitated by the addition of ammonium hydroxide or oxalic acid to a catalyst which has been previously impregnated with a rare-earth chloride solution.

U.S. Pat. No. 4,921,824 discloses an improved catalytic cracking catalyst, which contains separate and discrete particles of lanthanum oxide. The lanthanum oxide particles are added separate from and along with the catalyst during the cracking process. The lanthanum oxide additive may include an inert matrix such as clay, silica and/or a metal oxide.

Great Britain 2 140 791 discloses the preparation of SOx gettering agents which comprise lanthanum oxide dispersed essentially as a monolayer on the surface of alumina. The lanthanum oxide-alumina compositions may be admixed with or incorporated in FCC catalysts that comprise zeolite, clay and an alumina sol binder such as aluminum chlorhydroxide.

U.S. Pat. No. 4,843,052 and U.S. Pat. No. 4,940,531 disclose acid-reacted metakaolin catalysts. The catalysts can be used for the catalytic cracking of hydrocarbon feedstocks that contain high levels of metals such as Ni and V.

U.S. Pat. No. 4,465,779 discloses modified cracking catalyst compositions which include a diluent that contains a magnesium compound. The compositions are used to process feedstocks having very high metals (Ni & V) content.

### SUMMARY OF THE INVENTION

It is an object of the present invention to improve catalytic cracking catalyst compositions containing metals passivating compounds that are based on rare earth, and in particular an object to provide a highly effective composition for controlling the adverse effects of metals such as V and Ni, but which can also be prepared using readily available sources of rare earth.

It is a further object to provide zeolite-containing catalytic cracking catalysts wherein significant improvement in catalyst performance is obtained by the addition of a novel rare-earth containing composition.

It is yet a further object to provide a method for preparing cracking catalysts in which discrete particles of rare-earth compound, preferably lanthanum carbonate, are effectively and efficiently dispersed throughout the catalyst particles.

An additional object is to provide an improved method for the catalytic cracking of hydrocarbons wherein the catalysts of the present invention are reacted under catalytic conditions with hydrocarbon feedstocks that contain significant quantities of metals such as V and Ni.

The invention is in general a composition comprising discrete particles that comprise rare-earth carbonate compound dispersed in matrix. The rare earth compound preferably comprises lanthanum, but can also comprise other rare earths such as cerium. Alumina is a preferred matrix. The discrete particles preferably comprise about 20 to about 80% by weight rare earth carbonate compound.

It has been found that the catalytic performance of zeolite-containing cracking catalysts in the presence of Ni and V may be improved by utilizing the composition of this invention. The invention can be combined with zeolite-containing catalysts by admixing the invention with the zeolite catalysts. A preferred embodiment containing zeolite is a cracking catalyst composition wherein the zeolite is in discrete particles separate from the discrete particles that comprise rare earth compound dispersed in matrix.

The composition of this invention can be prepared as follows:
(a) preparing a mixture of rare-earth carbonate compound and alumina precursor compound;
(b) spray drying the mixture from (a) into particles having an average particle size in the range of 10 to about 150 microns, and in which rare earth carbonate compound is dispersed throughout matrix; and
(c) optionally calcining the composition resulting from (b).

In certain embodiments, the spray dried particles from (b) are processed to have a Davison Attrition Index in the range of 0 to 30.

These and still further objects will become readily apparent to one skilled-in-the-art from the following detailed description and specific examples.

### DETAILED DESCRIPTION OF THE INVENTION

The invention can be prepared using techniques and materials commonly utilized to prepare particulated fluidized cracking catalysts and/or additives. In particular, conventional matrix materials such as alumina and spray drying techniques utilized to make known rare earth-based particulates, such as those described above, are suitable. It has been found, however, that compositions comprising rare earth carbonate can be more readily prepared compared to the clay bound rare earth oxalates described in U.S. Pat. No. 5,364,516. The manufacture of the invention also does not have the limitations that the impregnation techniques have in preparing the zeolite catalysts impregnated with rare earth as described in U.S. Pat. No. 3,930,987.

The rare earth carbonate compound used to make this invention is commonly available in powder form having particle sizes in the range of 1 to 100 microns. Lathanum carbonate is preferred, but carbonates of other rare earths are also suitable, i.e., cerium, praseodymium, neodymium, promethium, and samarium. The rare-earth carbonate used in the invention may contain essentially 100 percent of one rare earth, e.g., lanthanum, or may comprise carbonates wherein a mixture of rare earths are present, e.g., up to about 60 weight percent of other rare-earths. A mixture of lanthanum and cerium are common, with cerium comprising up to about 30% by weight, and typically less than 10%.

Rare earth carbonates are typically prepared by precipitation from a lanthanum salt, e.g., chloride or nitrate, solution and an appropriate carbonate source such as sodium carbonate or ammonium carbonate. The particle size of rare earth carbonate recovered and processed can vary, but is typically in the range of 1 to 100 microns.

For the purposes of this invention, rare earth carbonate can include rare carbonate compounds containing anionic moieties in addition to carbonate, e.g., hydroxyl groups. These rare earth carbonates can therefore include rare earth hydroxycarbonates such as lanthanum hydroxylcarbonate. Such rare earth carbonates can be formed from rare earth salts and a carbonate source containing the additional anionic moiety.

The rare earth carbonate can be used “as is” when introducing the compound to water to form a slurry of rare earth carbonate and matrix precursor. The rare earth carbonate and matrix precursor are mixed at room temperature for a time such that a homogenous slurry is formed.

Matrix precursor can be any inorganic oxide or other material conventionally used to manufacture particulated fluidized cracking catalysts and/or additives. Alumina is a preferred matrix material. Alumina precursor can be any aluminum-containing compound capable of forming alumina matrix once it is dried and processed. Aluminum hydroxychloride is often used to prepare alumina-based matrix in particulates destined for use in fluidized catalytic cracking processes.

Matrix precursor is added to the slurry in amounts relative to the rare carbonate such that the final rare earth carbonate-containing particulate of the invention contains about 20 to about 80% rare earth carbonate. The amount of rare earth carbonate in the invention is expressed herein as rare earth oxide, an expression that is conventional in the art. In particular, techniques available to those skilled in art, e.g., ion-coupled plasma (ICP) analysis, require destruction of the analyzed compound into ionic constituents. It is these constituents that are then analyzed. The composition of these analytes is expressed on an oxide basis.

Matrix precursors other than those for alumina include silica, silica-alumina, and clay. Acid-reacted metakaolin clay such as that described in U.S. Pat. No. 5,364,516, the contents of which are incorporated by reference, is suitable. Briefly, such clays are obtained by heating kaolin at a temperature of about 700 to 910° C. for at least one minute to obtain reactive metakaolin. The reactive kaolin is then reacted with an acid, preferably hydrochloric acid, in amounts of up to about 1.5 moles of acid per mole of reactive metakaolin to obtain a reaction mixture that comprises acid-reacted metakaolin dispersed in an aqueous solution of acid leached alumina, i.e. aluminum chloride.

Indeed, the matrix of this invention may optionally contain a mixture of two or more different materials, e.g., based on materials selected from the aforementioned group of precursors. Clay and alumina precursors, for example, may be employed together to form a matrix for the particulates of this invention. Typical amounts of clay in the final product can be in the range of about 10 to about 50 weight percent of the final particulate, with the other matrix component, e.g., alumina, being present in amounts of 20 to about 80 percent and the rare carbonate being present in amounts of about 20 to about 80% depending on the amount of matrix desired.

Once matrix precursors and rare earth carbonate are selected and mixed, typically in slurry form having a solids content in the range of 20 to 60% by weight, the mixture is transferred to a spray drier and the slurry can be spray dried at an inlet temperature in the range of 550 to 950° F., and outlet temperature of 275 to 350° F., under conditions to produce particles having a size range of 10 to 150 microns in which rare-earth carbonate is dispersed throughout the matrix. The average particle size of the invention is generally in the range of 50 to 80 microns.

While it is believed that the spray dried particles comprise mostly rare earth carbonate dispersed throughout the matrix, the matrix precursor and the rare earth carbonate can react to form a mixed rare earth matrix precursor salt that is dispersed through the matrix, albeit in relatively small amounts. For example, if lanthanum hydroxycarbonate and aluminum hydroxyl chloride are used to make the invention, the spray dried particles may contain various reaction product salts such as LaAl₂(OH)₈Cl.

The particles from the spray drier constitute one embodiment of the invention. Optionally, the particles can be calcined at a temperature of 1000 to 1200° F. for up to about 1 hour, in which event, the rare-earth carbonate is converted to rare-earth oxide or rare earth oxychloride. It may be desirable to calcine the invention if a need arises to enhance the green strength of the invention prior to mixing it with other material, e.g., catalysts, or prior to introducing the invention to the catalyst inventory of an FCC unit. The invention may also be calcined just after mixture with other materials such as catalysts, but prior to introduction to the final application.

The particles of the invention possess the following physical properties:

(1) Davison attrition Index of 1 to 25;
(2) Average bulk density (ABD) of 0.6 to 1.1 g/cc; and
(3) Surface area of 10 to 200 m²/g.

The Davison Index (DI) is determined as follows:

A sample of catalyst is analyzed to determine the 0 to 20 micron size content. The sample is then subjected to a 1 hour test in a Fluid Catalyst Attrition Apparatus using a hardened steel jet cup having a precision bored orifice. An air flow of 21 liters a minute is used. The Davison Index is a ratio calculated as follows:

$$Davison Index = \frac{( wt . \% 0 \text{-} 20 micron material formed during the test )}{( wt . original 20 micron + fraction )}$$

Surface area is measured using conventional BET methodology.

The invention may be combined with zeolite to form another embodiment of the invention. In particular, the rare-earth compound particulate may be combined with conventional zeolite-containing fluid cracking catalysts (FCC), such as Kristal™, Ultra™ and Impact™ catalysts manufactured and sold by the Grace Davison business unit of W. R. Grace & Co.—Conn. The rare-earth carbonate particulate may be combined with the zeolite catalyst as a separate component in a blend, or as a component integral to the zeolite-containing particle.

FCC catalysts typically comprise a zeolite or molecular sieve such as type X, Y, ultrastable Y (USY), rare earth exchanged Y (REY), Beta, and/or ZSM-5 dispersed in silica, alumina, synthetic silica-alumina, or naturally occurring silica-alumina clay matrix. Preferred zeolites are disclosed in U.S. Pat. No. 3,402,996 (CREX and CREY), U.S. Pat. No. 3,293,192, U.S. Pat. No. 3,449,070 (USY), U.S. Pat. Nos. 3,595,611, 3,607,043, 3,957,623 (PCY) and 3,676,368 (REMY). The FCC catalyst may be prepared in accordance with the teachings of U.S. Pat. No. 3,957,689, CA 967,136, U.S. Pat. No. 4,499,197, U.S. Pat. No. 4,542,118 and U.S. Pat. No. 4,458,023.

The particulate of the present invention are preferably combined with the conventional zeolite-containing FCC catalysts in amounts ranging from 5 to 25 weight percent, and more preferably 5 to 15 weight percent. The rare earth carbonate particulate may be combined with the FCC catalysts as a separate particulate component before or during use in a catalytic cracking process. Alternatively, the invention may be integrated as mentioned above into the zeolite catalyst particulate by adding the rare-earth carbonate compound, either as powder or as a separate matrix-containing particulate, into a spray drier feed for manufacturing a conventional FCC catalyst particulate.

The invention is used in FCC processes conducted at cracking reaction temperatures of 500 to 600° C. and regeneration temperatures of 600 to 850° C. using hydrocarbon feedstocks that may contain up to 100 ppm or more of V and Ni. Petroleum feedstocks originating from Mexican or Columbian crude frequently have metals in these concentrations, and the invention would be particular useful when cracking such feeds. It is found that the presence of the invention during the FCC process passivates the adverse effects of metals such as vanadium and decreases the formation of hydrogen and coke. It is anticipated that use of the invention will permit the successful use of FCC regeneration catalysts that contain as much as 10,000 to 20,000 ppm V.

The following examples are given for illustrative purposes only and are not meant to be a limitation on the claims appended hereto.

All parts and percentages are by weight unless otherwise indicated. Further, any range of numbers recited in the present specification or claims, such as that representing a particular set of properties, units of measure, conditions physical states or percentages, is intended to literally incorporate expressly herein by reference or otherwise, any number falling within such range, including any subset of numbers within any range so recited.

### EXAMPLES

### Example 1

### Preparation of Invention

The formulation for the invention expressed as the oxides is nominally:
50 wt. % Al₂O₃ from aluminum hydroxychloride
50 wt. % La₂O₃ from lanthanum carbonate.

35.2 lbs of lanthanum carbonate powder (71% La₂O₃) were blended with 54.3 lbs of aluminum hydroxychloride solution (23% Al₂O₃). The slurry was well mixed and spray dried (inlet temperature 650° F., outlet temperature 300° F.) to form microspheres with a suitable particle size distribution for FCC conditions. The chemical and physical properties are shown in Table 1. The chemical analysis results are expressed as the wt. % of the oxide, except the total volatiles are wt. %.

TABLE 1
Chemical Properties

| Chemical | |
|---|---|
| Analysis | |
| expressed as oxide | |
| Na₂O | 0.06 |
| Al₂O₃ | 47.64 |
| RE₂O₃ | 45.12 |
| SO₄ | 0.00 |
| Fe₂O₃ | 0.00 |
| Cl | 1.11 |
| Total volatiles | 37.2 |
| Physical | |
| Properties | |
| DI | 1 |
| ABD, gr/cc | 0.93 |
| SA, m²/gr | 32 |
| Average particle size | 72 |
| 0-20, wt. % | 2 |
| 0-40, wt. % | 5 |
| 0-80, wt. % | 64 |
| 0-105, wt % | 91 |
| 0-149, wt. % | 100 |

### Example 2

### Activity Testing by ACE

A test sample was prepared which comprises a 10% by weight blend of the material prepared according to Example 1 with 90% by weight of a commercial zeolite containing cracking catalyst (KRISTAL™-1667 catalyst manufactured and sold by Grace Davison, a business unit of W. R. Grace and Co.—Conn. A base case (comparison) sample comprising 100% KRISTAL-1667 catalyst was also prepared.

The samples were calcined in air for one hour at 400° F., then three hours at 1100° F. They were then impregnated to 5000 ppm V from a solution of V-naphthenate, and calcined for one hour at 400° F., and then 1100° F. and held for three hours to remove the carbon. The samples were steam deactivated by cyclic propylene steaming (CPS) procedures according to Lori T. Boock, Thomas F. Petti, and John A. Rudesill, ACS Symposium Series, 634, 1996, 171-183, and D. Wallenstein, R. H. Harding, J. R. D. Nee, L. T. Boock, Applied Catalysis A: General 204, 2000, 89-106.

The chemical and physical properties of the steam-deactivated samples are shown in Table 2.

TABLE 2
Chemical and Physical Properties

| Sample (wt %) | Base Catalyst | Base + 10% Example 1 |
|---|---|---|
| Al₂O₃, %: | 47.083 | 47.173 |
| La₂O₃, %: | 1.83 | 5.515 |
| RE₂O₃, %: | 3.082 | 6.692 |
| V, %: | 0.516 | 0.529 |
| T.V., %: | 0.24 | 0.3 |
| Surface Area, m²/g: | 111 | 119 |
| Matrix SA, m²/g: | 31 | 31 |
| Zeolite SA, m²/g: | 80 | 88 |

As shown in Table 2 the zeolite surface area of the Base+10% Example 1 is 10% higher than the Base even though the sample is diluted by 10% from the blend, showing that Example 1 improves the zeolite surface area retention with the poisoning of 5000 ppm V.

The samples were then catalytically tested using the ACE (Advanced Catalyst Evaluation) unit described in U.S. Pat. No. 6,069,012. The surface area retention improvement is realized as an increase in activity when compared at constant catalyst-to-oil ratio of 6, as shown in Table 3.

TABLE 3
Activity and Selectivity Testing

| | | Base Catalyst + 10% |
|---|---|---|
| | Base Catalyst | Example 1 |
| Conversion | 63.52 | 66.80 |
| Coke | 4.04 | 3.28 |
| Hydrogen | 0.47 | 0.32 |
| Methane | 0.67 | 0.65 |
| Ethylene | 0.45 | 0.48 |
| Tot C₁ + C₂ | 1.54 | 1.53 |
| Dry Gas | 2.01 | 1.84 |
| Propylene | 3.26 | 3.70 |
| Propane | 0.59 | 0.66 |
| Total C₃'s | 3.85 | 4.35 |
| 1-Butene | 1.17 | 1.29 |
| Isobutylene | 1.61 | 1.62 |
| Trans-₂-butene | 1.34 | 1.49 |
| Cis-₂-butene | 1.06 | 1.17 |
| Total C₄ = s | 5.18 | 5.56 |
| IsoButane | 2.09 | 2.67 |
| n-C₄ | 0.62 | 0.72 |
| Total C₄s | 7.88 | 8.95 |
| LPG Wt % | 11.73 | 13.30 |
| Wet Gas | 13.74 | 15.15 |
| Gasoline | 45.75 | 48.37 |
| LCO | 25.99 | 24.17 |
| Bottoms | 10.48 | 9.03 |

As shown in Table 3 the blend of Base Catalyst with 10% Example 1 had higher conversion and lower coke and hydrogen than Base Catalyst, which shows the improved vanadium tolerance of Example 1.

What is claimed:

1. A composition comprising discrete particles that comprise rare-earth carbonate compound dispersed in matrix.

2. The composition of claim 1 wherein the discrete particles comprise about 20 to about 80% rare earth carbonate.

3. The composition of claim 1 wherein the matrix comprises alumina.

4. The composition of claim 2 wherein the matrix comprises alumina.

5. The composition of claim 1 further comprising zeolite.

6. The composition of claim 1 wherein the rare earth compound is lanthanum carbonate.

7. The composition of claim 2 wherein the rare earth compound is lanthanum carbonate.

8. The composition of claim 1 wherein the rare earth carbonate is a carbonate of a mixture of two or more rare earth elements.

9. The composition of claim 1 wherein the discrete particles a particle size in the range of 10 to 150 microns.

10. A catalytic cracking catalyst composition comprising zeolite admixed with discrete particles comprising the composition of claim 1.

11. The catalytic cracking composition of claim 10 wherein the zeolite is in discrete particles separate from the discrete particles comprising the composition of claim 1.

12. A method for the catalytic cracking of hydrocarbons which comprises cracking a vanadium-containing hydrocarbon in the presence of the catalyst of claim 10 under catalytic cracking conditions.

13. A method for preparing a particulate composition which comprises:
(a) preparing a mixture comprising rare-earth carbonate compound and matrix precursor compound;
(b) spray drying the mixture from (a) into particles having an average particle size in the range of 10 to about 150 microns and in which rare carbonate is dispersed throughout matrix; and
(c) optionally calcining the composition resulting from (b).

14. The method of claim 13 wherein the mixture of (a) further comprises clay.

15. The method of claim 13 wherein the spray dried particles from (b) have a Davison attrition index of 0 to 30.

16. The method of claim 13 wherein the matrix precursor in (a) is aluminum hydroxychloride.

17. The method of claim 13 wherein the rare earth carbonate compound is lanthanum carbonate.

18. The method of claim 16 wherein the rare earth carbonate compound is lanthanum carbonate.
